(19) United States
(12) Patent Application Publication
(10) Pub. No.: US 2023/0110480 A1
(43) Pub. Date: Apr. 13, 2023

(54) MOUNTING BRACKETS, FILTER UNITS CONFIGURED TO COUPLE TO THE MOUNTING BRACKETS AND RELATED METHODS

(71) Applicant: CommScope Italy S.R.L., Agrate Brianza (IT)

(72) Inventors: Antonio Sala, Agrate Brianza (IT); Riccardo Massa, Treviglio (IT)

(21) Appl. No.: 17/905,287

(22) PCT Filed: Mar. 24, 2021
(86) PCT No.: PCT/EP2021/057521

§ 371 Date: Aug. 30, 2022

Related U.S. Application Data
(60) Provisional application No. 62/993,852, filed on Mar. 24, 2020.

(30) Foreign Application Priority Data
Aug. 21, 2020 (IT) 102020000020305

(51) Int. Cl. H01Q 1/24; H01P 1/20; F16B 3/00; H01Q 1/12

(52) U.S. Cl. CPC H01Q 1/246; H01P 1/20; F16B 3/00; H01Q 1/1221

(57) ABSTRACT

The present invention provides target devices such as filter units with a plurality of external projection members that project outwardly from the target device and cooperate with apertures in a mounting bracket whereby the target device can be slidably moved from a first position to a second position provided by a lobe of the apertures to couple the target device to a respective support structure using a respective mounting bracket. The mounting bracket can be provided as a plurality of mounting brackets, including a first one attached to the support structure and a first side of a first target device and a second one attached to a second side of the first target device and to a first side of a second target device thereby allowing the first and second target devices to be stacked together to a common support structure.

### FIELD OF THE INVENTION

The present invention relates generally to mounting brackets that are particularly suitable for use with filter units of cellular communications systems.

### BACKGROUND

Wireless base stations are well known in the art and typically include, among other things, baseband equipment, radios and antennas. The antennas are often mounted to a support structure such as a tower or other elevated structure such as a pole, rooftop, wall, water tower or the like. Typically, multiple antennas are mounted on the support structure, and one or more baseband units and radios can be connected to each antenna. Each antenna provides cellular service to a defined coverage area or “sector.”

FIG. 1 is a highly simplified, schematic diagram that illustrates a conventional cellular base station 10. As shown in FIG. 1, the cellular base station 10 includes a support structure (shown as an antenna tower) 30 and an equipment enclosure 20 that is located at the base of the antenna tower 30. A plurality of baseband units 22 and radios 24 are located within the equipment enclosure 20. Each baseband unit 22 is connected to a respective one of the radios 24 and is also in communication with a backhaul communications system 44. Sectorized antennas 32 (labelled as three antennas 32-1, 32-2, 32-3) are located at the top of the antenna tower 30. Cables 34 (which are bundled together in FIG. 1 to appear as a single cable) connect the radios 24 to the respective antennas 32. Each cable 34 may be connected to a filter unit 50 (labeled as filter units 50-1, 50-2, 50-3) and both the transmit and receive signals for each radio 24 may be carried on a single (coaxial and/or fiber optic) cable 34. In many cases, the radios 24 are located at the top of the tower 30 instead of in the equipment enclosure 20 in order to reduce signal transmission losses. The filter units 50 may be located, for example, within or adjacent the antennas 32.

Cellular base stations typically use directional antennas 32 such as phased array antennas to provide increased antenna gain throughout a defined coverage area. A typical phased array antenna 32 may be implemented as a linear array of radiating elements mounted on a panel, with perhaps 5-20 radiating elements per linear array. Typically, each radiating element is used to (1) transmit radio frequency (“RF”) signals that are received from a transmit port of an associated radio 24 and (2) receive RF signals from mobile users and feed such received signals to the receive port of the associated radio 24. Filter units, such as duplexers, are typically used to connect the radio 24 to each respective radiating element of the antenna 32. A “duplexer” refers a well-known type of multi-port filter assembly that is used to connect both the transmit and receive ports of a radio 24 to an antenna 32 or to a sub-array of radiating elements of an antenna 32. Duplexers are used to isolate the RF transmission paths to the transmit and receive ports of the radio 24 from each other while allowing both RF transmission paths access to the radiating element of the antenna 32, and may accomplish this even though the transmit and receive frequency bands may be closely spaced together.

FIGS. 2A and 2B illustrate a prior art mounting assembly used to mount a filter unit 50 to a support structure such as a pole using with prior art brackets 60 that are screwed onto first and second ends of a housing 50h of the filter unit 50. Each bracket 60 has a segment that is adjacent a connector 80 of the filter unit 50. Each bracket 60 is connected to a strap 70 that couples the filter unit 50 to a support structure such as a pole. The brackets 60 and straps are attached to the filter unit 50, then the filter unit 50 is coupled to the support structure. However, the filter unit 50 and brackets 60 can be relatively heavy (about 10 kg or about 22 pounds) which can make it uncomfortable to support while a user attaches the straps 70 to the support structure. Also, the use of a screw into the housing 50h to attach the brackets 60 can sometimes corrode over time due to environmental exposure and thus introduce a weak point into the filter housing 50h.

### SUMMARY OF EMBODIMENTS OF THE INVENTION

Embodiments of the present invention provide mounting brackets that slidably, detachably couple to filter units and that may be used to mount the filter units to a support structure.

Embodiments of the present invention provide mounting brackets that are attachable to a support structure prior to coupling to a target housing, such as a filter unit, and the filter unit can be aligned with apertures on the mounting bracket, then slidably coupled thereto into an assembled position.

Embodiments of the present invention provide housings with a plurality of spaced apart outwardly projecting members (i.e., standoffs) on a rear wall that are receivable into aligned apertures of a mounting bracket that is pre-attachable to a support structure, optionally a pole or wall.

The filter unit in any of the embodiments of the aspects of the present invention can be a duplexer, a diplexer, a combiner, TDA (Tower mounted amplifier) and/or any other devices such as filters for cellular communications systems and other applications.

The connector assemblies may be useful for other applications.

Embodiment are directed to support assembly that includes: a housing having a rear wall and a front wall, a top and a bottom defining an enclosure; a plurality of outwardly projecting members extending from the rear wall and spaced apart over a length and width dimension thereof; and a mounting bracket with a plurality of spaced apart apertures. Some of the plurality of spaced apart apertures can be configured to slidably receive the plurality of outwardly projecting members.

The plurality of spaced apart apertures can include a plurality of spaced apart lobed apertures. The lobed apertures can have a center space that merges into at least one laterally and/or longitudinally extending lobe of smaller size.

The plurality of spaced apart apertures can further include a plurality of longitudinally and/or laterally spaced apart pairs of strap apertures that receive straps that couple to a support structure, optionally a pole.

The plurality of spaced apart apertures can further include a plurality of spaced apart corner apertures sized and configured to receive fixation members to couple to a support structure, optionally a wall.

The mounting bracket can be a single piece monolithic body having a three dimensional shape with opposing primary surfaces. The plurality of spaced apart lobed apertures and the strap apertures can reside in a common first plane. The corner apertures can reside in a different second plane from the lobed apertures and the strap apertures.

The mounting bracket can be a first mounting bracket. The housing can be a first housing. The front wall of the first housing can have a plurality of projecting members. The support assembly can also include a second mounting bracket having a plurality of spaced apart apertures. Some (a subset) of the plurality of spaced apart apertures of the second mounting bracket can be configured to receive the plurality of outwardly projecting members of the front wall.

The housing can be a first housing. The support assembly can further include a second housing with a rear wall and a front wall, a top and a bottom defining an enclosure. The second housing can have a plurality of outwardly projecting members extending from the rear wall. The plurality of outwardly projecting members extending from the rear wall of the second housing and the plurality of projecting members extending from the front wall of the first housing can be held in different lobes of the same lobed apertures of the second mounting bracket.

The front wall of the first housing can be held a distance of 1 mm-2 cm from the rear wall of the second housing with the second mounting bracket therebetween to thereby define a low profile connection structure.

The projecting members can have a head having a first radius, a neck having a second radius smaller than the first radius, and a base having a third radius greater than the second radius. The neck can have a length that corresponds to a thickness of the mounting bracket adjacent the lobe of the lobed aperture neighboring the neck,. The projecting members can have an overall projecting distance in a range of about 1 mm to 2 cm.

The housing can be a housing of a filter unit of a communications system. The mounting bracket can be a universal mounting bracket that is configured to couple to a wall and a pole as a target support structure using some of the same and some different apertures of the plurality of apertures provided by the mounting bracket.

The mounting bracket can further include spaced apart tabs that may extend outwardly from an outer perimeter of the mounting bracket that couple to respective locking members to lock the housing in position.

Other embodiments are directed to a mounting bracket. The mounting bracket includes a three dimensional mounting bracket body. The mounting bracket body has opposing first and second primary surfaces with a plurality of spaced apart lobed apertures extending through the first and second primary surface. The lobed apertures have a center space that merges into at least one laterally and/or longitudinally extending lobe of smaller size. The mounting bracket body also includes a plurality of longitudinally and/or laterally spaced apart pairs of strap apertures that receive straps that couple to a support structure, optionally a pole, and a plurality of spaced apart corner apertures sized and configured to receive fixation members to couple to a support structure, optionally a wall.

The mounting bracket can be a single piece monolithic body having the three dimensional mounting bracket body that positions the plurality of spaced apart lobe apertures and the strap apertures in a common, first plane and positions the corner apertures in a different second plane.

The three dimensional mounting bracket body can have a laterally extending or longitudinally extending medial segment that extends a width or length of the mounting bracket body and defines a valley when the first primary surface faces outward and defines a peak when the second primary surface faces outward.

The plurality of lobed apertures can be four lobed apertures. The plurality of spaced apart pairs of strap apertures can be four pairs of strap apertures, including first and second cooperating pairs of strap apertures that couple to straps and hold the mounting bracket in a first orientation for a vertical pole and third and fourth pairs of strap apertures that couple to straps and hold the mounting bracket in second orientation for a horizontal pole.

The plurality of lobed apertures can be spaced apart over a width dimension and length dimension of the mounting bracket and at least one can reside in each different quadrant thereof.

The mounting bracket can have tabs that couple to one or more locking members to provide secure positional stability of the target device.

Yet other aspects are directed to methods of attaching a target device to a support structure. The methods include: providing a mounting bracket that includes a plurality of spaced apart lobed apertures; attaching the mounting bracket to a support structure; then aligning projecting members of a target device with the lobed apertures of the mounting bracket; and sliding the projecting members into a lobe of the lobed apertures to couple the target device to the support structure using the mounting bracket.

The provided mounting bracket can further include a plurality of spaced apart strap apertures. The support structure can be a pole. The attaching can include coupling at least one support strap to the pole and to at least one pair of strap apertures of the plurality of spaced apart strap apertures of the mounting bracket. The mounting bracket can couple to the pole in either a horizontal or a vertical orientation using different selected sets of pairs of the strap apertures, with first and second straps extending either horizontally through a first set of selected pairs of the strap apertures for the vertical orientation or vertically through a second set of selected pairs of the strap apertures for the horizontal orientation.

The provided mounting bracket can further include a plurality of corner apertures, and the attaching can include attaching fixation members through the corner apertures and into a wall as the support structure.

The target device can be a first filter unit that has a front wall and a rear wall, each with the projecting members. The mounting bracket can be a first mounting bracket. The first mounting bracket can be coupled to the projecting members of the rear wall. The method can further include: providing a second mounting bracket with a plurality of spaced apart lobed apertures; aligning projecting members of the front wall with the lobed apertures of the second mounting bracket; then sliding the projecting members of the front wall into a first lobe of the lobed apertures of the second mounting bracket.

The method can further include: providing a second filter unit with a rear wall comprising projecting members; aligning projecting members of the rear wall with the lobed apertures of the second mounting bracket; then sliding the projecting members into a second lobe of the lobed apertures of the second mounting bracket from whereby the projecting members of the front wall of the first filter unit and the projecting members of the rear wall of the second filter unit are held in the same lobed apertures of the second mounting bracket thereby providing a stacked multi-filter unit assembly coupled to the support structure using the first and second mounting brackets.

Still other aspects are directed to a filter unit that includes: a housing with a rear wall and a front wall, a top and a bottom; connectors extending from the top and bottom configured to couple to cables; and a plurality of projecting members that extend outwardly from the rear wall and that are spaced apart over a length and width dimension thereof

The projecting members can have a head having a first radius, a neck having a second radius smaller than the first radius, and a base having a third radius greater than the second radius. The projecting members can extend outwardly from the front wall a distance in a range of about 1 mm to about 2 cm.

The filter unit can also include another plurality of projecting members that extend outwardly from the front wall and that are spaced apart over a length and width dimension thereof.

### BRIEF DESCRIPTION OF THE DRAWINGS

FIG. 1 is a highly simplified, schematic diagram of a conventional cellular base station.

FIG. 2A is a rear perspective view of a prior art filter unit and mounting bracket assemblies for coupling the filter unit to a support structure, shown as a pole.

FIG. 2B is a front, side perspective view of the prior art devices shown in FIG. 2A.

FIG. 3A is a front view of a mounting bracket, shown coupled to an upright mounting pole, according to embodiments of the present invention.

FIG. 3B is a front view of the mounting bracket shown in FIG. 3A, but shown coupled to a mounting pole in a different orientation according to embodiments of the present invention.

FIG. 4A is a front view of another embodiment of a mounting bracket according to embodiments of the present invention.

FIG. 4B is a front view of yet another embodiment of a mounting bracket according to embodiments of the present invention.

FIG. 5 is a front perspective view of the mounting bracket shown in FIG. 3A and adjacent a filter unit according to embodiments of the present invention.

FIG. 6A is a front view of the mounting bracket shown in FIG. 3A but with the mounting bracket in a first pre-installed position according to embodiments of the present invention.

FIG. 6B is a front view of the mounting bracket shown in FIG. 6A but with the mounting bracket shown in a second-fully installed position according to embodiments of the present invention.

FIG. 7 is a front, side perspective view of the mounting bracket shown in FIG. 3A but coupled to a different support structure according to embodiments of the present invention.

FIG. 8 is a front view of the mounting bracket shown in FIG. 7 coupled to the support structure shown in FIG. 7.

FIG. 9 is a front view of the mounting bracket coupled to the support structure shown in FIG. 8 and further coupled to a filter unit according to embodiments of the present invention.

FIG. 10 is a front perspective view of a mounting bracket coupled to another embodiment of a filter unit according to embodiments of the present invention.

FIG. 11 is a front perspective view of the assembly shown in FIG. 10 and with the filter unit further coupled to a second mounting bracket according to embodiments of the present invention.

FIG. 12 is a side view of an example of a stacked assembly of multiple filter housings and multiple mounting brackets coupled to a single (common) support structure according to embodiments of the present invention.

FIG. 13A is a top, perspective view of the stacked assembly shown in FIG. 12 to illustrate exemplary connectors of the filter unit according to embodiments of the present invention.

FIG. 13B is an enlarged view of the stacked assembly shown in FIG. 13A.

FIG. 14A is a side view of the mounting bracket shown coupled to the support structure shown in FIGS. 7 and 8 and further coupled to a filter housing according to embodiments of the present invention.

FIG. 14B is a partial side perspective view of the assembly shown in FIG. 14A.

FIG. 15 is an example kit or package containing at least one mounting bracket according to embodiments of the present invention.

FIG. 16 is a flow chart of actions that can be used to couple a filter unit to a support structure using a mounting bracket according to embodiments of the present invention.

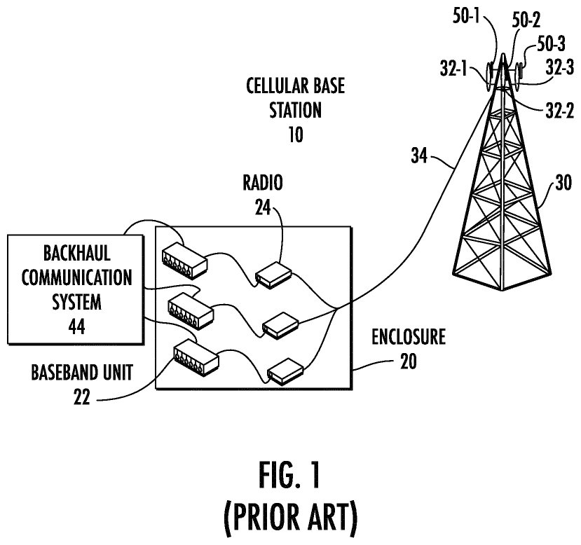

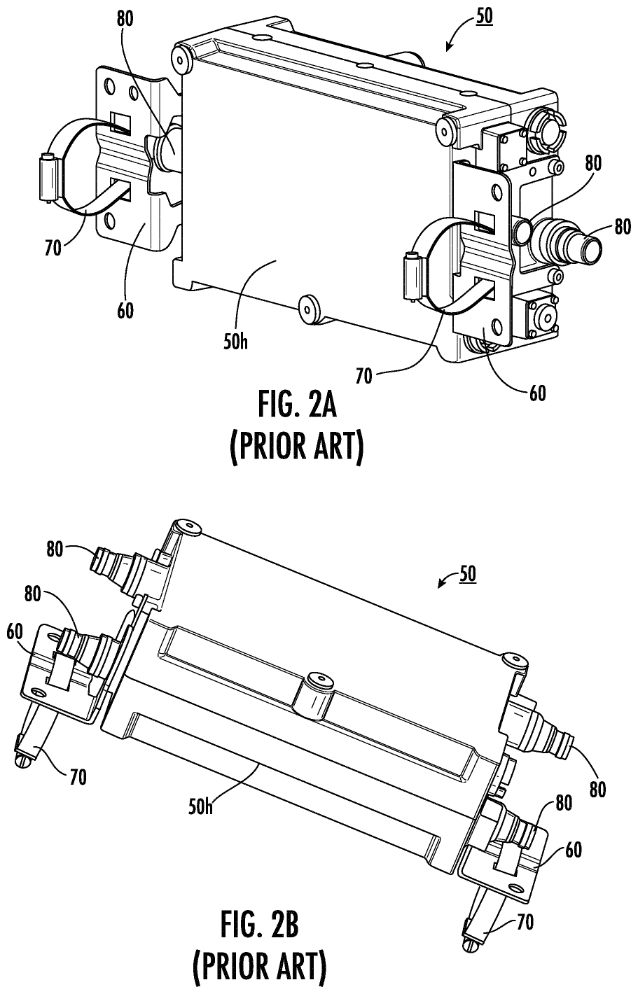

### DETAILED DESCRIPTION

The present invention is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. The terms “FIG.” and “Fig.” are used interchangeably with the word “Figure” in the specification and/or figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

The term “about” means that the noted parameter can vary somewhat from the stated number, typically by +/−20%.

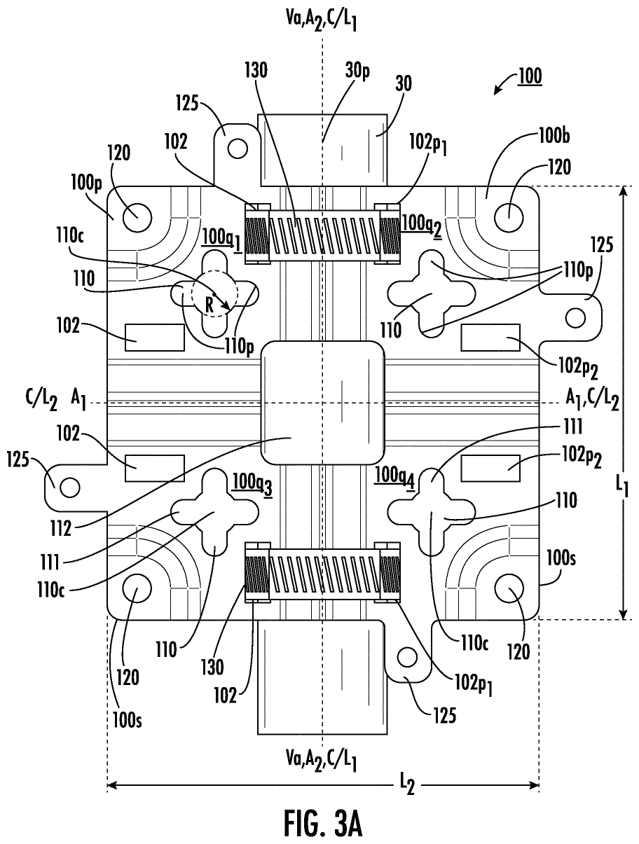

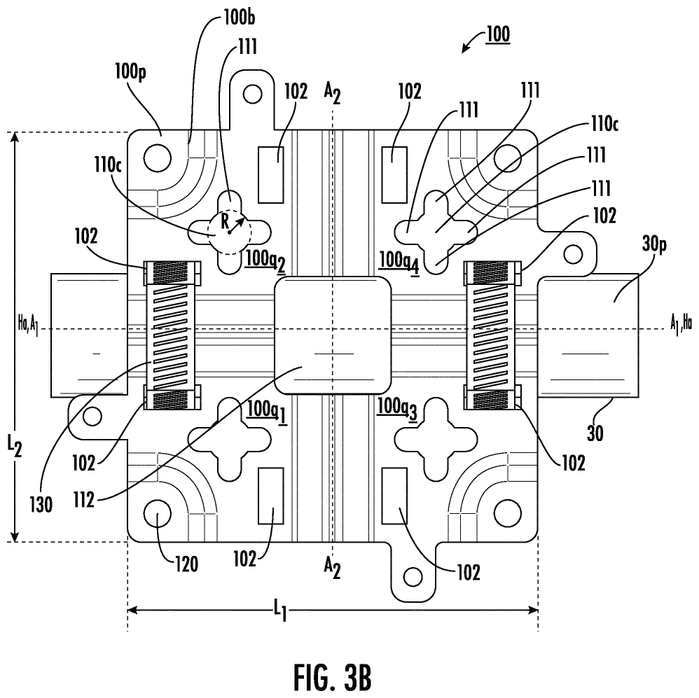

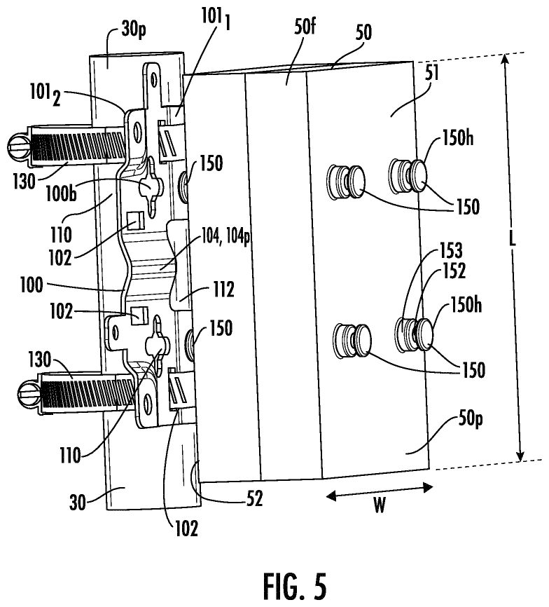

Referring to FIGS. 3A and 3B, embodiments of the present invention provide a mounting bracket 100 that is configured to slidably engage a housing 50h of a target device 50, such as a filter unit 50f (FIG. 5). The mounting bracket 100 can detachably couple to the housing 50h without requiring permanent or screwed attachments to the target housing 50h. The term “filter unit” is used interchangeably herein with the term “filter assembly” or “filter”. The filter unit 50f can be duplexers, diplexers, combiners, TDA (Tower Mounted Amplifier) and/or any other filters for cellular communications systems and other applications.

The mounting brackets 100, while particularly suitable for filter units 50, is also suitable for mounting other target devices for other end use applications.

As shown in FIGS. 3A and 3B, the mounting bracket 100 can comprise a plurality of different shaped apertures. As shown, the mounting bracket 100 can include strap apertures 102, which can be rectangular, corner apertures 120, which can be circular, and an optional center aperture 112, which can be larger than the strap and corner apertures 102, 120, respectively, and can optionally be polygonal, such as square or rectangular, as shown. The mounting bracket 100 also includes a plurality of spaced apart lobed apertures 110.

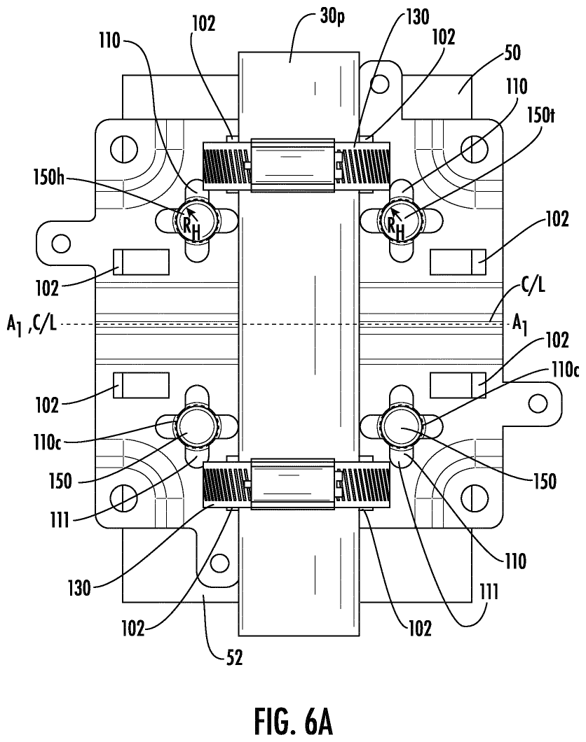

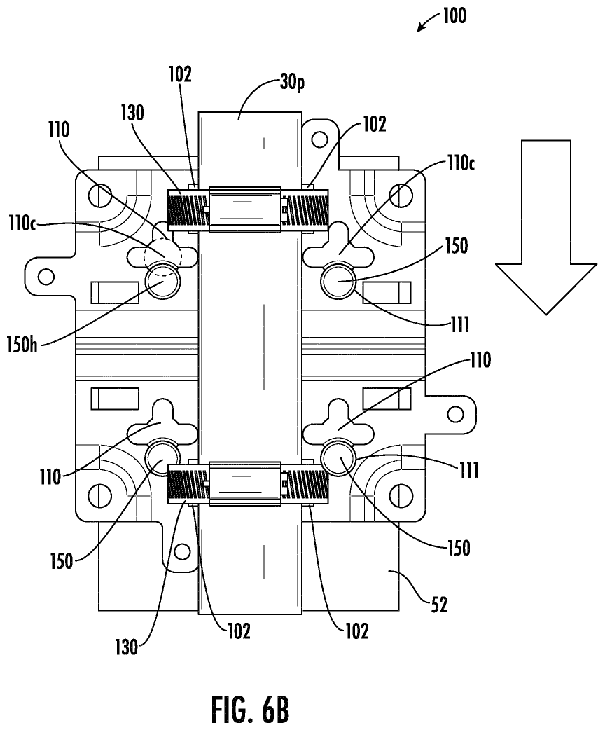

The lobed apertures 110 comprise at least one lobe 111 of smaller width than a center space 110c of the lobed aperture 110. The center space 110c of the lobed aperture can have a circular shape with a radius R that is equal to or within 10% larger of a radius of head 150h of a standoff or projecting member 150 (FIGS. 5, 6A). The projecting member 150 extends out from a primary external surface or wall 50p of a housing 50h and is slidably receivable into the center space 110c, then slidably placed into a desired lobe 111 of a respective lobed aperture 110. Stated differently, the center space 110c of the lobed aperture 110 merges into at least one outwardly extending channel of smaller width forming a respective lobe 111. Thus, a respective lobe 111 can extend radially, laterally and/or longitudinally outward from a respective center of a center space 110c of the lobed aperture 110. The terms “laterally” and “longitudinally” are used broadly to refer to outwardly extending directions from the center of the center space 110c. The lobes 111 can have the same length or different lengths. The lobes 111 can have a length that is typically is at least 50% of the radius R of the center space 110c and/or the head 150h of the projecting member 150, more typically in a range of 0.5×R-10×R.

There can be a plurality of spaced apart lobed apertures 110, shown as four, but 2-10 or even more lobed apertures 110 may be used. The lobed apertures 110 can all be used for each mounting application or selected ones can be used for different target devices 50, e.g., filter units 50f.

The mounting bracket 100 has a body 100b that has opposing primary surfaces 101₁, 101₂ providing the strap, lobed and corner through apertures 102, 110, 120 that can be spaced apart over a length and width dimensions thereof.

The mounting bracket 100 can be a “universal” mounting bracket 100 that can attach to a plurality of different support structures 30, such as a wall 30w and a pole 30p, and the same support structure type (e.g., a pole) that can be in either vertical or horizontal orientations by merely selecting the appropriate primary surface to face outward and using a selected sub-set of each of the different apertures.

FIG. 3A illustrates the bracket 100 coupled to a pole 30p in an upright orientation using first and second straps 130 coupled to two longitudinally spaced apart pairs of the four pairs of the strap apertures 102. FIG. 3B illustrates the bracket 100 coupled to a pole 30p in a horizontal orientation using first and second straps 130 and a different subset of the strap apertures 102 (e.g., two pairs of laterally spaced apart apertures 102) from those used in FIG. 3A. The first primary surface 101₁ faces outward. The first pairs of strap apertures 102p1 can be aligned and spaced apart along a first centerline of the mounting bracket and the second pairs of strap apertures 102p2 can be aligned and spaced apart along a second centerline (C/L₂) of the mounting bracket that intersects the first centerline (C/L₁).

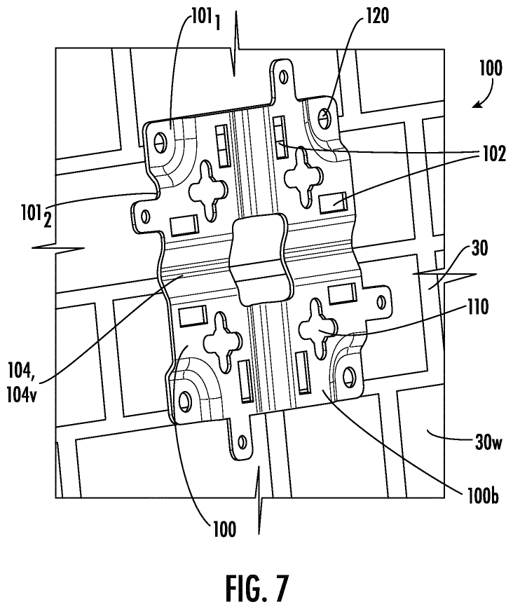

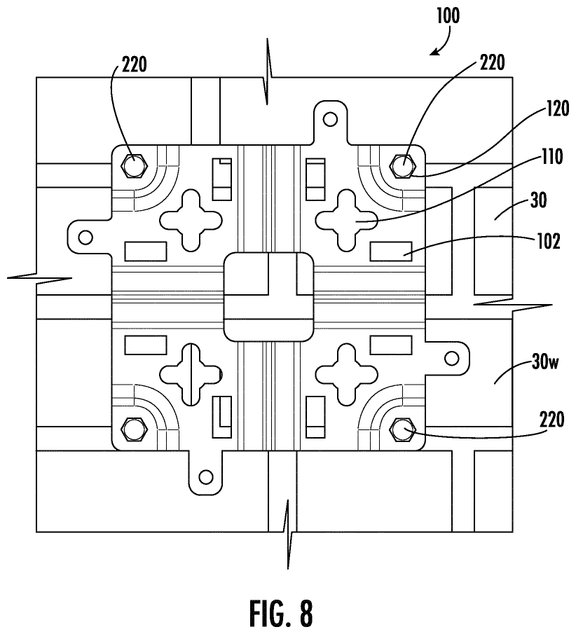

Referring to FIGS. 7 and 8, the bracket 100 is coupled to a wall 30w as the support structure, and uses the corner apertures 120 to attach to the wall 30w using wall mounting attachment members 220 without using the strap apertures 102. The second primary surface 101₂ faces outward.

Referring to FIGS. 5, 6A and 6B, a target device 50 is shown that can be adjacent and/or coupled to the mounting bracket 100. The target device 50 can include a plurality of projecting members 150 coupled to a respective plurality of the lobed apertures 110. The projecting members 150 comprise a head 150h with a radius R_{H}, that merge into a neck 152 of smaller radius, that in turn merges into a base 153 of greater radius. The base 153 can have the same radius as the head 150h or have a larger radius. The neck 152 can have a length that corresponds to a thickness (e.g., is about the same or greater than the thickness by less than 1-2 mm) of the mounting bracket 100 at the lobe 111 of the lobed aperture to securely couple to the projecting member 150 and not allow back to front sliding movement when secured to the lobes 111 of the respective lobed apertures 110. The neck 152 can have an outwardly extending length that is between 1-100 mm. The projecting members 150 can have an overall length that is in a range of about 1 mm to about 2 cm.

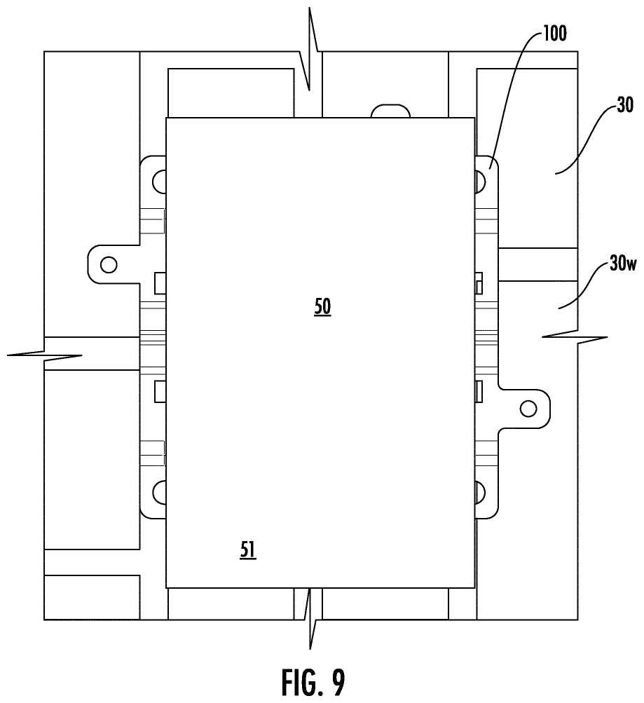

As shown in FIG. 5, the housing 50h has a front wall 51 and an opposing rear wall 52 and a top 50t and a bottom 50b defining an enclosure. The rear wall 52 faces the support structure 30. At least the rear wall 52 includes the plurality of spaced apart and outwardly projecting members 150. In this embodiment, both the front wall 51 and the rear wall 52 can comprise the projecting members 150 allowing for stacked devices 50, such as filter units 50f (e.g., double, tri and quad) as will be discussed below. FIG. 9 illustrates that only the rear wall 52 comprises the projecting members 150 with the front wall 51 devoid of these projecting members 150.

The projecting members 150 can be spaced apart over a length and width dimension of the rear wall 52 (and front wall 51, in some embodiments). That is, as shown in FIG. 5, there can be a plurality of projecting members 150, shown as four, but more or less than four may be used, such as a number in a range of 3-12. The projecting members 150 can reside above and below and to each side of horizontal and vertical centerlines of the respective walls 51, 52 for support balance.

FIG. 6A illustrates a first position of the target device 50 relative to the mounting bracket 100 with the projecting members 150 aligned with center spaces 110c of a plurality of lobed apertures 110. The mounting bracket 100 is pre-attached to the support structure 30, which is a pole 30p as shown, before the target device 50 is mounted to the mounting bracket 100. FIG. 6B illustrates a single sliding directional movement (here downward as shown by the arrow) to position the projecting members 150 in respective downwardly extending lobes 111 of the lobed apertures 110 to couple the target device 50 to the mounting bracket 100.

The housing 50h can be easily removed by sliding the housing 50h in an opposing direction, in the embodiment of FIG. 6B, that would be upward, to align the projecting members with the center space 110c of the lobed apertures 110 and decouple the housing from the mounting bracket 100.

Referring to FIGS. 5 and 7, the mounting bracket 100 can have a body 100b with a three dimensional shape that positions the corner apertures 120 in a different plane than the strap apertures 102 and/or the lobed apertures 110. The lobed apertures 110 can be co-planar with the strap apertures 102. The body 100b can have an intermediate segment 104 that defines a peak 104p (FIG. 5) that faces outward with the first primary surface 101₁ facing outward (away from the support structure 30) and a valley 104v (FIG. 7) that faces outward when turned over with the second primary surface 101₂ facing outward (away from the support structure 30). The three-dimensional shape can provide a low-profile interface between different support structures 30, such as poles 30p and walls 30w, by merely orienting the mounting bracket 100 in a desired orientation. As shown in FIG. 7, the corner apertures 120 are closer to the wall 30w than the strap apertures 102 or the lobed apertures 110 and abut the wall 30w for attachment.

As shown in FIGS. 3A and 3B, the mounting bracket 100 may also include spaced apart tabs 125 that extend outward from the perimeter 100p from different sides 100s.

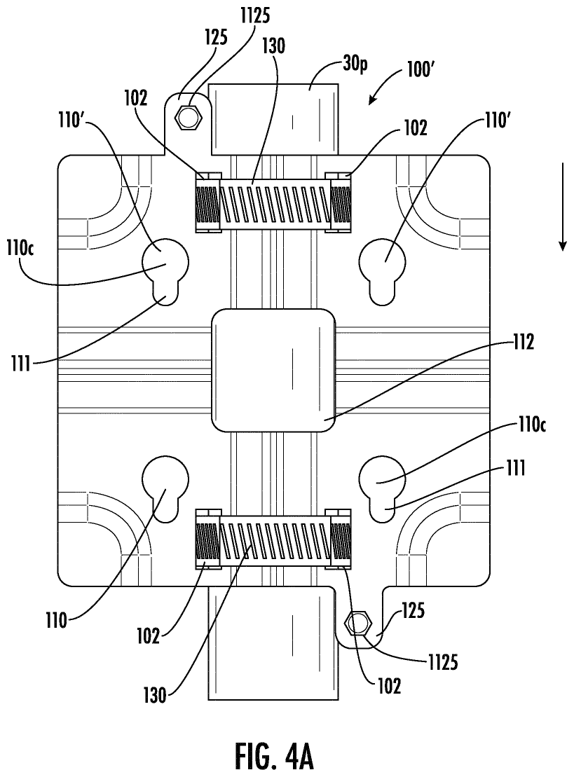

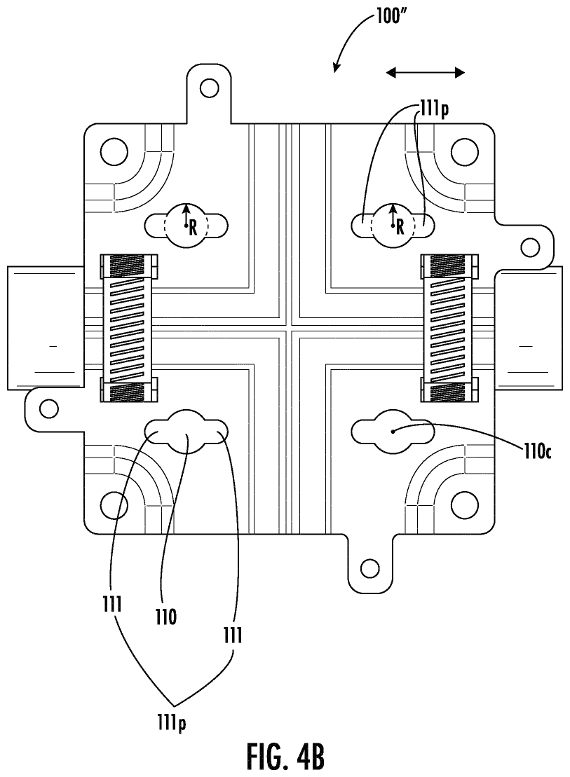

As also shown in FIGS. 3A and 3B, the lobed apertures 110 comprise a plurality of (shown as four) lobes 111, including a pair 111p of vertically aligned lobes 111 and a pair 111p of horizontally aligned lobes 111 radially extending from the center 110c of a respective lobed aperture 110. However, the lobed apertures 110 can comprise other numbers of lobes. For example, the lobed apertures 110′ can include a single lobe 111 as shown in FIG. 4A or the lobed apertures 110″ can have a single pair of aligned apertures 111p as shown in FIG. 4B.

FIG. 4A also illustrates that the mounting bracket 100′ does not require the corner apertures 120 (FIG. 3A). That is, the mounting brackets 100′ can be provided for specific support structures and are not required to have a “universal” configuration.

FIG. 4B also illustrates that the bracket 100′ does not require a center aperture 112 (FIG. 3A). FIGS. 4A and 4B also illustrate that the mounting bracket 100′, 100″ comprises only four strap apertures 102 instead of eight as shown in FIG. 3A.

The mounting bracket 100 can comprise a monolithic body 100b with an outer perimeter 100p that can be polygonal, such as square or rectangular with four sides 100s. Each of the four sides 100s can have the same length “L”. As shown in FIGS. 3A and 3B, the four sides 100s can be defined by a pair of sides with a first length, L₁ and a pair of sides with a second length L₂. In some embodiments, L₁=L₂. In some embodiments, L₁>L₂. Example lengths L₁, L₂ include lengths in a range of about 5 cm to about 10 cm, such as about 5 cm, about 6 cm, about 7 cm, about 8 cm, about 9 cm and about 10 cm.

The mounting bracket 100 can have a thickness that is constant or that varies at different locations. The mounting bracket 100 can have a wall defining a lobed aperture 110 with a thickness in a range of about 1.5 mm and 4 mm, in some embodiments.

The mounting bracket 100 can be fabricated in any appropriate manner including, by way of example only, stamped, (die) cast, forged, injection molded or three-dimensionally printed.

The mounting bracket 100 can comprise metal or a polymer or combinations of same defining a sufficiently strong substrate that can support the weight of the target device 50. The target device 50, e.g., filter unit 50f, can have a weight that is in a range of about 5 kg-20 kg (about 10-40 pounds), such as about 10 kg (about 22 pounds). For outdoor use, the mounting bracket 100 can comprise a rust and/or corrosion-resistant material, paint and/or coating.

As shown in FIGS. 3A and 3B, the mounting bracket 100 can comprise a single-piece body 100b. In other embodiments, the mounting bracket 100 can be provided as one or more separate components that can remain separate or that can be coupled (not shown). The mounting bracket 100 can be metallic, a metal coated with a dielectric (e.g., rubber) or non-metallic.

The mounting bracket 100 can have a first centerline (C/L₁), which can correspond to a vertical centerline axis Va and a second centerline (C/L₂) which can correspond to a horizontal centerline axis Ha. The mounting bracket 100 can have four quadrants 100q1-100q4 defined by the neighboring regions residing adjacent the intersections of the axes or centerlines. One of the lobed apertures 110 resides in each of the four quadrants 100q1-100q4.

In some embodiments, the mounting bracket 100 can have a first axis of symmetry A₁ and/or a second axis of symmetry A₂. Thus, side of the mounting bracket is a mirror image. When the mounting bracket 100 is (virtually) folded in half along the axis of symmetry, the two halves match up with pairs of the strap apertures 102, corner apertures 120 and lobed apertures 110 having a common position. To be clear, as used herein, the term “axis of symmetry” refers to the mirror shape of the mounting bracket 100 and the positions of the corner apertures 120, the strap apertures 102 and the lobed apertures 110 but does not include the tabs 125, which can include apertures 125a.

Where used, one or more of the tabs 125 can engage one or more locking members 1125 (FIG. 4A) to lock the target device 50 in the assembled position relative to the support structure 30. The locking members 1125 can be screws, plastic plugs or have other locking configurations. The locking members/ may be used to prevent the head 150h of the projecting member 150 from being able to slide out of the lobe 111. That is, as gravitational pull based on the weight of the target device 50 can hold the housing 50h in its assembled position on the mounting bracket 100, locking members 1125 can engage one or more of the tabs 125 to lock the filter unit 50 in the assembled position and thereby prevent inadvertent movement based on external forces such as cable jarring, undue wind forces and physical interactions. As shown in FIG. 4A, the mounting bracket 100′ may include only first and second tabs 125, one extending down (corresponding to the lobe 111) and the first one extending up, in a direction opposite the second tab 125.

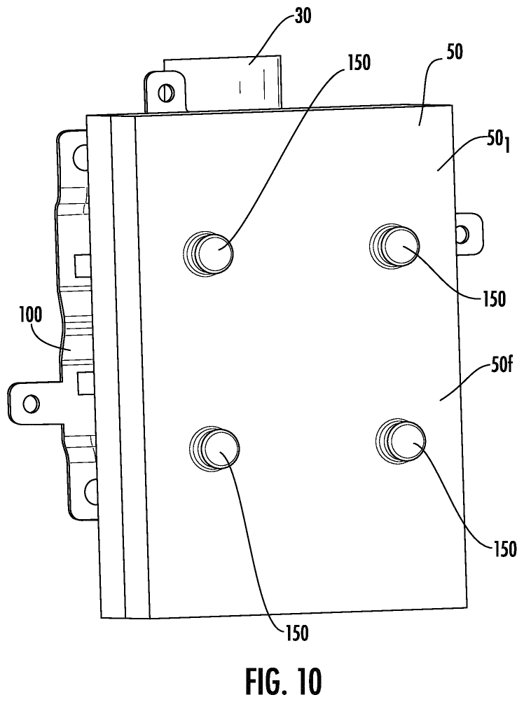

FIG. 10 shows the projecting members 150 on the front wall 51 and the rear wall 52.

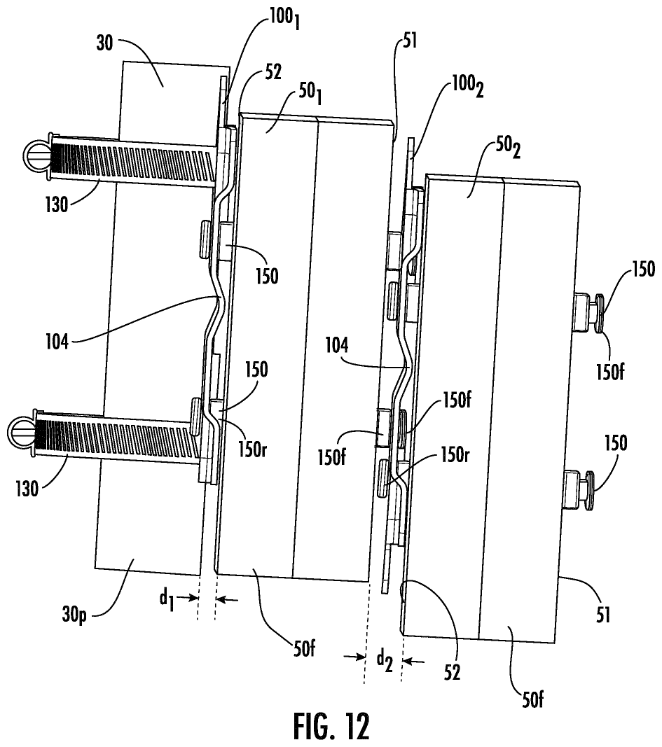

FIG. 12 shows the projecting members 150 on the rear wall 52 are coupled to a first mounting bracket 100₁ that is coupled to the support structure 30, shown as a pole 30p. The projecting members 150 on the front wall 51 of a first target device 501 are coupled to a second mounting bracket 100₂. As shown, the projecting members 150 on the front wall 51 of the first target device 50₁ are positioned in respective lobes 111 that are above respective center spaces 110c.

FIG. 12 illustrates a second target device 502 coupled to the second mounting bracket 100₂ using the same lobed apertures 110 but a different lobe 111 of the respective lobed apertures 110. Here the different lobes are the lower lobes 111 that are aligned with the upper lobes 111 of a corresponding lobed aperture 110 that are occupied by projecting members 150 of the first target device 50₁.

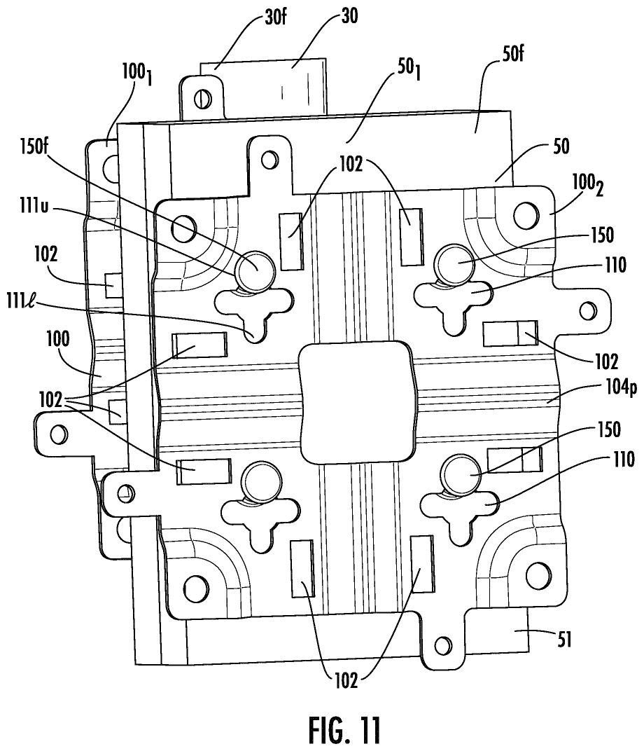

Referring to FIGS. 11 and 12, the front projecting members 150f of the first target device 50₁ are held in upper lobes 111u of the lobed apertures 110 of the mounting bracket 100 while the rear projecting members 150r of the second target device 50₂ are held in aligned lower lobes 111/of corresponding ones of the lobed apertures 110. The front projecting members 150f can be assembled to the bracket 100 before or after the rear projecting members 150r. The weight of the second target device 50₂ can effective lock the front projecting members 150f into the upper lobes 110u and the rear projecting members 150r into the lower lobes 110 and place the two target devices 50₁, 50₂ in close proximity.

FIG. 12 also illustrates that the first mounting bracket 100₁ can provide a low profile connection to the support structure 30, shown as a pole 30p, with a distance “d1” between the rear wall 52 and the pole 30p. The distance “d1” can be in a range of 1 mm-1 cm. The second mounting bracket 1002 can provide a low profile connection distance “d2” between the first and second target devices 50₁, 50₂ and “d2” can be in a range of 1 mm-1 cm. In some embodiments, d1 is less than d2.

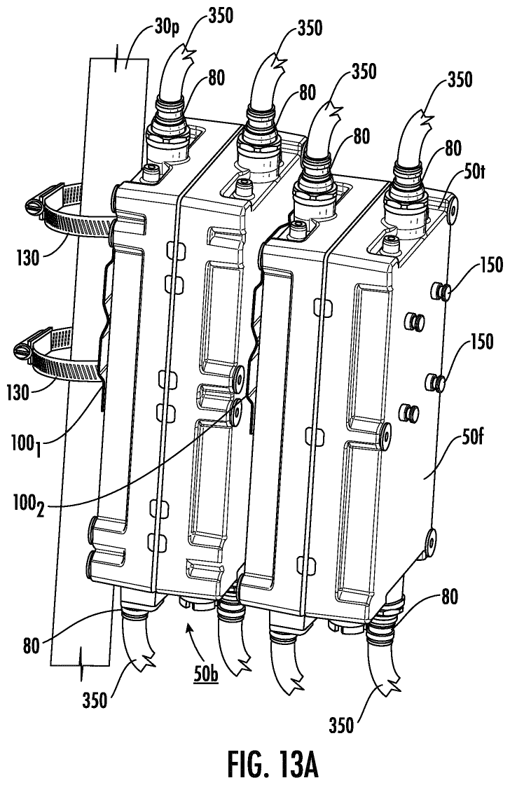

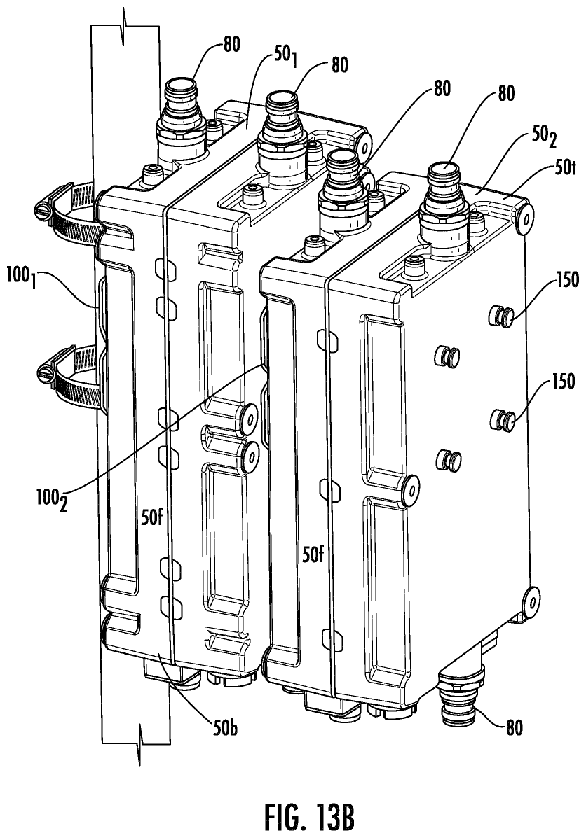

Referring to FIGS. 13A and 13B, that the target devices 50₁, 50₂ can be filter units 50f that comprise connectors 80 extending from a top 50t and a bottom 50b that can be coupled to cables 350.

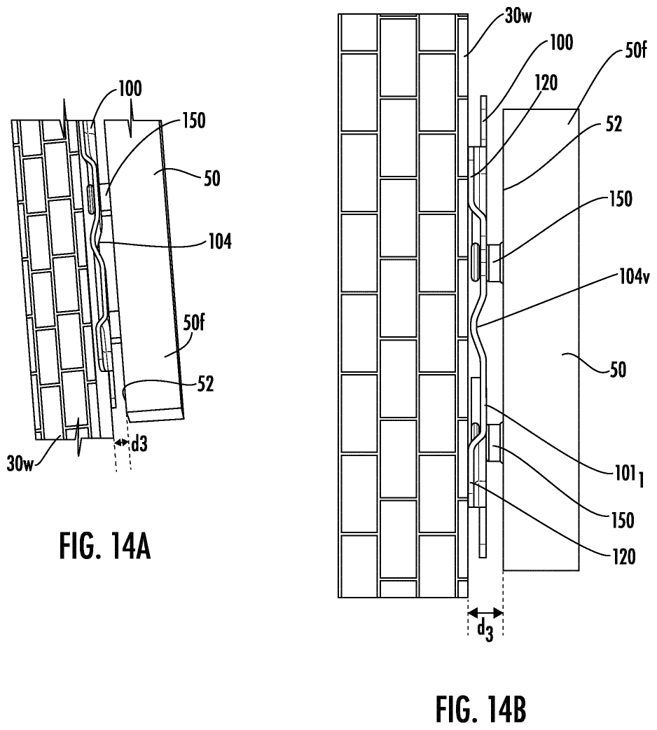

FIGS. 14A and 14B illustrate the mounting bracket 100 coupled to a wall 30w as the support structure, as discussed with respect to FIGS. 7 and 8, and also coupled to a target device 50. The connection can be a low profile connection with the distance between the rear wall 52 of the device 50 and the support wall 30w being a distance “d3” that can be in a range of about 1 mm to about 1 cm. The first primary surface 101₁ is facing outward with the valley 104v facing outward and with the corner apertures 120 residing in a plane that is adjacent the support wall 30w.

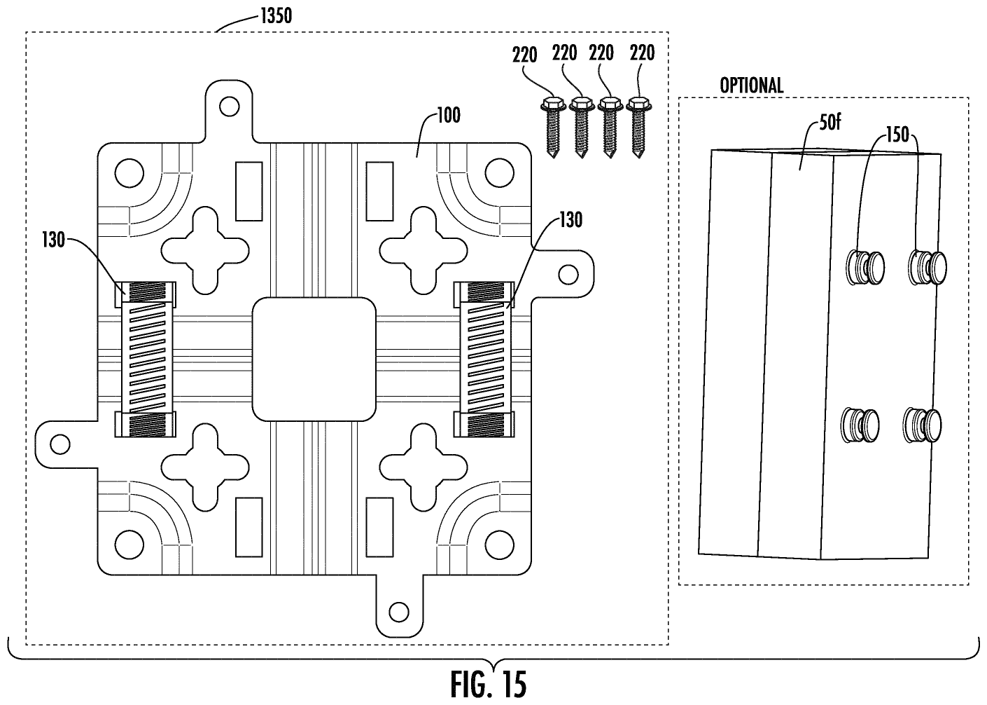

FIG. 15 illustrates that at least one mounting bracket 100 can be provided in a kit or package 350 for field installation, optionally with one or more of pole straps 130 typically disassembled or separate in the package, wall mounting hardware 220 and/or one or more filter units 50f.

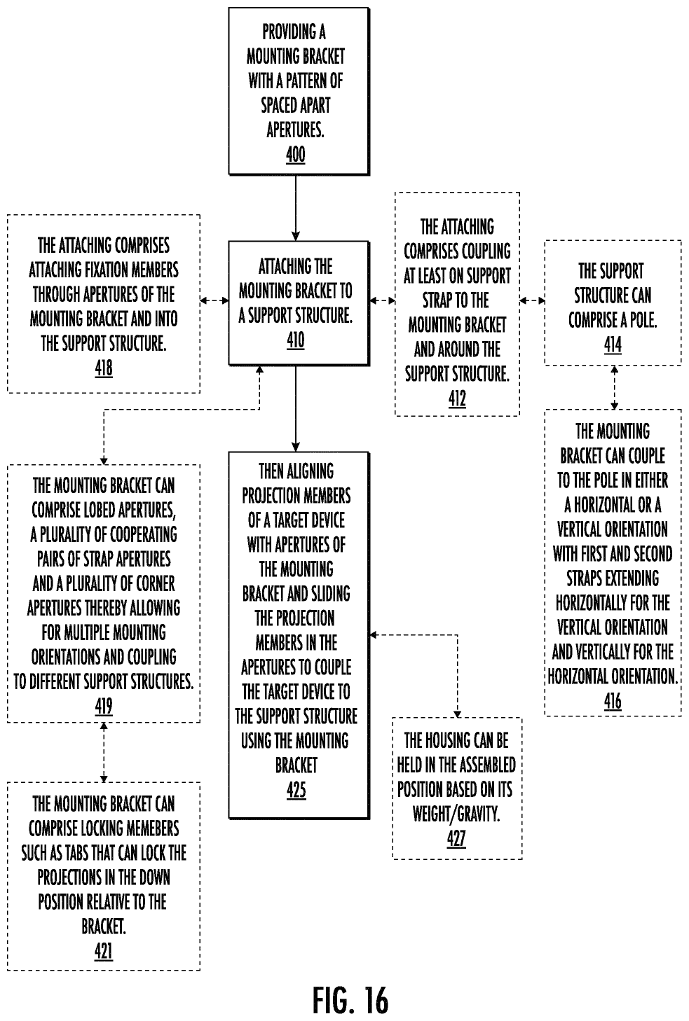

Turning now to FIG. 16, a flow chart of example actions that can be used to attach a target device, such as a filter unit, to a support structure using a mounting bracket is illustrated (broken lines indicate optional steps). A mounting bracket with a pattern of spaced apart apertures is provided (block 400). The mounting bracket is attached to a support structure (block 410). Then, projection members of a target device are aligned with apertures of the mounting bracket and the projection members are slid into the apertures to couple the housing to the support structure using the mounting bracket (block 425).

The housing can be held in the assembled position based on its weight/gravity (block 427)

The attaching comprises coupling at least one support strap to the mounting bracket and around the support structure (block 412).

The support structure can comprise a pole (block 414).

The mounting bracket can couple to the pole in either a horizontal or a vertical orientation with first and second straps extending horizontally for the vertical orientation and vertically for the horizontal orientation (block 416).

The attaching comprises attaching fixation members through apertures of the mounting bracket and into the support structure (block 418).

The mounting bracket can comprise lobed apertures, a plurality of cooperating pairs of strap apertures and a plurality of corner apertures thereby allowing for multiple mounting orientations and coupling to different support structures (block 419).

The mounting bracket can comprise locking members such as tabs that can lock the projections in the down position relative to the bracket (block 421).

The filter unit 50f can comprise a plurality of resonator plates, elements or cavities that are mounted within a housing to realize a resonant cavity RF filter. For example, if the filter unit 50f includes resonator plates 450, 460, they can be mounted within the housing 50h. The resonator plates may be mounted in a stacked relationship. The resonator plates may be fixed to the housing by continuous solder joints and/or may be die cast integrally with other elements of the housing to provide very high levels of RF and PIM distortion performance. In some embodiments, the filter assemblies 50f may comprise three port devices such as RF duplexers or diplexers and one or more can comprise a receiving channel 150 that can comprise threads 151 that can releasably engage a connector assembly 160. In other embodiments, the filter units 50′ may include additional ports to implement multiplexers, triplexers, combiners or the like or tower or other parts (e.g., to implement band pass or band stop filters). See, U.S. Pat. No. 10,050,323 for additional discussions of example filter assemblies, the contents of which are hereby incorporated by reference as if recited in full herein. Other filter unit configurations may be used.

It will be appreciated that mounting brackets 100 according to embodiments of the present invention may be used to mount to and couple with a wide variety of different devices including duplexers, diplexers, multiplexers, combiners, TDAs and the like. It will also be appreciated that the mounting brackets 100 according to embodiments of the present invention may also be used in applications other than cellular communications systems.

The present invention has been described above with reference to the accompanying drawings, in which certain embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A support assembly comprising:
a housing comprising a rear wall and a front wall, a top and a bottom defining an enclosure;
a plurality of outwardly projecting members extending from the rear wall and spaced apart over a length and width dimension thereof; and
a mounting bracket comprising a plurality of spaced apart apertures, wherein some of the plurality of spaced apart apertures are configured to slidably receive the plurality of outwardly projecting members.

2. The support assembly of claim 1, wherein the plurality of spaced apart apertures comprises a plurality of spaced apart lobed apertures, and wherein the lobed apertures comprise a center space that merges into at least one laterally and/or longitudinally extending lobe of smaller size.

3. The support assembly of claim 2, wherein the plurality of spaced apart apertures further comprise a plurality of longitudinally and/or laterally spaced apart pairs of strap apertures that receive straps that couple to a support structure, optionally a pole.

4. The support assembly of claim 3, wherein the plurality of spaced apart apertures further comprise a plurality of spaced apart corner apertures sized and configured to receive fixation members to couple to a support structure, optionally a wall.

5. The support assembly of claim 4, wherein the mounting bracket is a single piece monolithic body having a three dimensional shape with opposing primary surfaces, wherein the plurality of spaced apart lobed apertures and the strap apertures reside in a first plane and the corner apertures reside in a different second plane, and optionally wherein the mounting bracket further comprises spaced apart tabs extending outwardly from an outer perimeter of the mounting bracket that couple to respective locking members to lock the housing in position.

6. The support assembly of claim 1, wherein the mounting bracket is a first mounting bracket, wherein the front wall of the housing comprises a plurality of projecting members, and wherein the support assembly further comprises a second mounting bracket comprising a plurality of spaced apart apertures, wherein some of the plurality of spaced apart apertures of the second mounting bracket are configured to receive the plurality of outwardly projecting members of the front wall.

7. The support assembly of claim 6, wherein the housing is a first housing, wherein the support assembly further comprises a second housing with a rear wall and a front wall, a top and a bottom defining an enclosure, wherein the second housing comprises a plurality of outwardly projecting members extending from the rear wall, wherein the plurality of outwardly projecting members extending from the rear wall of the second housing and the plurality of projecting members extending from the front wall of the first housing are held in different lobes of the same lobed apertures of the second mounting bracket.

8. The support assembly of claim 7, wherein the front wall of the first housing is held a distance of 1 mm-2 cm from the rear wall of the second housing with the second mounting bracket therebetween to thereby define a low profile connection structure.

9. The support assembly of claim 2, wherein the projecting members comprise a head having a first radius, a neck having a second radius smaller than the first radius, and a base having a third radius greater than the second radius, wherein the neck has a length that corresponds to a thickness of the mounting bracket adjacent the lobe of the lobed aperture neighboring the neck, wherein the projecting members have an overall projecting distance in a range of about 1 mm to about 2 cm.

10. The support assembly of claim 1, wherein the housing is a housing of a filter unit of a communications system, and wherein the mounting bracket is a universal mounting bracket that is configured to couple to a wall and a pole as a target support structure using some of the same and some different apertures of the plurality of apertures provided by the mounting bracket.

11. A mounting bracket, comprising:
a three dimensional mounting bracket body, wherein the mounting bracket body comprises opposing first and second primary surfaces;
a plurality of spaced apart lobed apertures extending through the first and second primary surface, wherein the lobed apertures comprise a center space that merges into at least one laterally and/or longitudinally extending lobe of smaller size;
a plurality of longitudinally and/or laterally spaced apart pairs of strap apertures that receive straps that couple to a support structure, optionally a pole; and
a plurality of spaced apart corner apertures sized and configured to receive fixation members to couple to a support structure, optionally a wall.

12. The mounting bracket of claim 11, wherein the mounting bracket is a single piece monolithic body having the three dimensional mounting bracket body that positions the plurality of spaced apart lobe apertures and the strap apertures in a common first plane and positions the corner apertures in a different second plane.

13. The mounting bracket of claim 11, wherein the three dimensional mounting bracket body comprises a laterally extending or longitudinally extending medial segment that extends a width or length of the mounting bracket body and defines a valley when the first primary surface faces outward and defines a peak when the second primary surface faces outward.

14. The mounting bracket of claim 11, wherein the plurality of lobed apertures is four lobed apertures, wherein the plurality of spaced apart pairs of strap apertures is four pairs of strap apertures, including first and second cooperating pairs of strap apertures that couple to straps and hold the mounting bracket in a first orientation for a vertical pole and third and fourth pairs of strap apertures that couple to straps and hold the mounting bracket in second orientation for a horizontal pole.

15. The mounting bracket of claim 11, wherein the plurality of lobed apertures are spaced apart over a width dimension and length dimension of the mounting bracket and at least one lobed aperture of the plurality of lobed apertures resides in each different quadrant thereof, optionally wherein the mounting bracket further comprises spaced apart tabs extending outwardly from an outer perimeter of the mounting bracket.

16. A method of attaching a target device to a support structure, comprising:
providing a mounting bracket comprising a plurality of spaced apart lobed apertures;
attaching the mounting bracket to a support structure; then
aligning projecting members of a target device with the lobed apertures of the mounting bracket; and
sliding the projecting members into a lobe of the lobed apertures to couple the target device to the support structure using the mounting bracket.

17. The method of claim 16, wherein the provided mounting bracket further comprises a plurality of spaced apart strap apertures, wherein the support structure comprises a pole, and wherein the attaching comprises coupling at least one support strap to the pole and to at least one pair of strap apertures of the plurality of spaced apart strap apertures of the mounting bracket, wherein the mounting bracket can couple to the pole in either a horizontal or a vertical orientation using different selected sets of pairs of the strap apertures, with first and second straps extending either horizontally through a first set of selected pairs of the strap apertures for the vertical orientation or vertically through a second set of selected pairs of the strap apertures for the horizontal orientation.

18. The method of claim 16, wherein the provided mounting bracket further comprises a plurality of corner apertures, and wherein the attaching comprises attaching fixation members through the corner apertures and into a wall as the support structure, and optionally wherein the provided mounting bracket comprises tabs extending outwardly from an outer perimeter thereof and the method comprises inserting locking members to lock the target device in position.

19. The method of claim 16, wherein the target device is a filter unit and comprises a front wall and a rear wall, each comprising the projecting members, wherein the mounting bracket is a first mounting bracket, wherein the first mounting bracket is coupled to the projecting members of the rear wall, and wherein the method further comprises:
providing a second mounting bracket comprising a plurality of spaced apart lobed apertures;
aligning projecting members of the front wall with the lobed apertures of the second mounting bracket; then
sliding the projecting members of the front wall into a first lobe of the lobed apertures of the second mounting bracket.

20. The method of claim 19, wherein the filter unit is a first filter unit, the method further comprising:
providing a second filter unit with a rear wall comprising projecting members;
aligning projecting members of the rear wall with the lobed apertures of the second mounting bracket; then
sliding the projecting members into a second lobe of the lobed apertures of the second mounting bracket from whereby the projecting members of the front wall of the first filter unit and the projecting members of the rear wall of the second filter unit are held in the same lobed apertures of the second mounting bracket thereby providing a stacked multi-filter unit assembly coupled to the support structure using the first and second mounting brackets.

21. A filter unit comprising:
a housing comprising a rear wall and a front wall, a top and a bottom;
connectors extending from the top and bottom configured to couple to cables; and
a plurality of projecting members that extend outwardly from the rear wall and that are spaced apart over a length and width dimension thereof.

22. The filter unit of claim 21, wherein the projecting members comprise a head having a first radius, a neck having a second radius smaller than the first radius, and a base having a third radius greater than the second radius, and wherein the projecting members extend outwardly from the front wall a distance in a range of about 1 mm to 2 cm.

23. The filter unit of claim 21, further comprising another plurality of projecting members that extend outwardly from the front wall and that are spaced apart over a length and width dimension thereof.
